(19) United States
(12) Patent Application Publication
(10) Pub. No.: US 2016/0374313 A1
(43) Pub. Date: Dec. 29, 2016

(54) Bulk feed storage and exchange bin

(71) Applicants: James Bradley Lahman, Atoka, OK (US); Clint Dodson, Durant, OK (US)

(72) Inventors: James Bradley Lahman, Atoka, OK (US); Clint Dodson, Durant, OK (US)

(21) Appl. No.: 14/545,818

(22) Filed: Jun. 23, 2015

(51) Int. Cl. A01K 5/01

(52) U.S. Cl. CPC A01K 5/0114

(57) ABSTRACT

A bulk feed bin providing storage, transport and dispensation of a quantity of particulate animal feed, the container having a gravity feed hopper with an upper sliding lid, a lower feed chute with a spring-loaded sliding closure, the bin providing an elevated lower base portion supporting the bin having a pair of skid rail slots use in lifting each bin with a skid loader or other lift equipment.

Each bin is stackable upon another, with each upper sliding lid being opened or closed while stacked and each chute sliding closure selectively opening and closing while stacked to evacuate the bin contents.

### CROSS REFERENCE TO RELATED APPLICATIONS

None.

### BACKGROUND OF INVENTION

1. Field of the Invention

A bulk feed bin providing storage, transport and dispensation of a quantity of particulate animal feed, the container having a gravity feed hopper with an upper sliding lid, a lower feed chute with a spring-loaded sliding closure, the bin providing an elevated lower base portion supporting the bin having a pair of skid rail slots use in lifting each bin with a skid loader or other lift equipment.

Each bin is stackable upon another, with each upper sliding lid being opened or closed while stacked and each chute sliding closure selectively opening and closing while stacked to evacuate the bin contents.

2. Description of Prior Art

A preliminary review of prior art patents was conducted by the applicant which reveal prior art patents in a similar field or general purpose. However, the prior art inventions do not disclose the same or similar elements as the present stackable bulk feed storage bins, nor do they present the material components in a manner contemplated or anticipated in the prior art.

Prior art bulk feed devices located for sale or being held under prior art patent do not provide stackable containers nor are they of a profile capable of transport in the bed of a standard pickup.

They also do not have the ability to provide a user with other appliances and contemplated with the bin being the only required portable components within a feed distribution system.

In U.S. Pat. No 6,408,787 to Clark, a feed bin is disclosed having a upper hinged lid, a lower slide plate below a tapered bin and an inner grate assembly to break up clumps in the feed product. It is intended for use suspended from a corral fence by a rear clip or wall of a horse trailer. It is not intended for use in a stacked or multiple unit assembly. Clark is also provided in a design patent, issued under U.S. Pat. No. D435706.

In U.S. Pat. No. 6,263,833 to Runyon, a pickup bed mounted feed distribution device presents an elongated box or hopper with a tapered bottom bin supplying a lower side distribution auger with a granular content for distribution into fee troughs. The Runyon bin comprises an upper lid which is opened for the introduction of feed into the bin, a lower frame supporting the bin bottom and auger above the bed of the pickup, and a side chute which is hinged to be folded up for transport and down during auger active distribution of the feed content. It is a single stack apparatus.

### SUMMARY OF THE INVENTION

The livestock industry relies upon particulate feed for food supplements for livestock and other animals. This particulate feed comes in two forms—bagged feed and bulk feed. Bagged feed is generally transported by trucks and comes stacked upon pallets or is sold in individual bags of feed. Bulk feed is delivered by truck or rail and is loaded either into a truck bed after purchase by a front end loader or is dispensed in a container by a hopper. A purchaser is most often required to pick up their bulk feed from a local feed store and either haul it with their own equipment or rent and/or borrow a transport vehicle to haul it to their location for storage and subsequent use.

The prior art demonstrates special trailers which are provided to haul and store bulk particulate feed—some of them even having built-in dispensaries to off-load the contained feed. When these devices are empty, the user simply takes them back for a refill or uses another means to deliver replacement feed for a next feeding.

It would be the intent of the present invention to provide the present stackable bulk feed storage , transport and exchange bin as a vessel use for particulate bulk feed handling. Each bin has an upper sliding lid within which the bulk feed materials are delivered to fill the bin with a chosen feed. The bin has a storage cavity defining a tapered feed hopper floor which directs the feed materials into a lower chute opening provided with a lower spring-loaded chute panel, which may opened against the spring tension to dispense the feed material through the lower chute by the activation of a laterally mounted chute lever. Each bin is filled with bulk feed at a bulk feed merchant, transported by the purchaser and stored until the feed is distributed through the floor to either another stackable bin or into a delivery container to the animal livestock after which the empty bin is transported back to the bulk feed merchant for refilling or for exchange with a filled bulk feed bin. Each bin is of a dimension to be transported in the bed of a pickup.

### DESCRIPTION OF THE DRAWINGS

The following drawings are submitted with this utility patent application.

FIG. 1 is an upper perspective view of a bulk feed transport and storage bin with phantom line indicating an stack base support upon which the bin may be set upon.

FIG. 2 is a plan view of the bulk feed transport and storage bin with phantom line indicating an upper second bin stacked upon the lower bin.

FIG. 3 is a side view of the bulk feed transport and storage bin with broken lines indicating the internal configuration of the bin, including the lower tapered floor and the lower chute door in a closed position with the corresponding positioned lever.

FIG. 4 is a top view of an open bulk feed transport and storage bin.

FIG. 5 is a bottom view of the bulk feed transport and storage bin with the lower chute door in an open position.

FIG. 6 is a sectional view of the bulk feed transport and storage bin along section line 6/6 of FIG. 5 showing the lower chute door in an open position.

FIG. 7 is a section view of the bulk feed transport and storage bin as seen in FIG. 6, except showing the lower chute door in an open position.

### DESCRIPTION OF THE PREFERRED EMBODIMENT

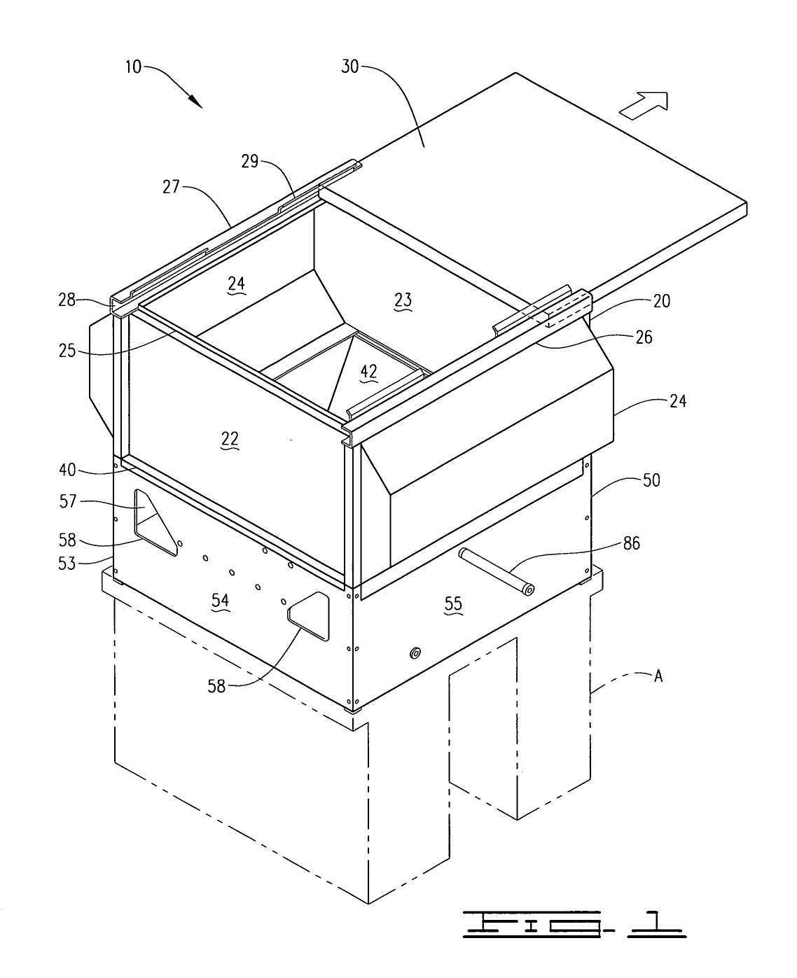

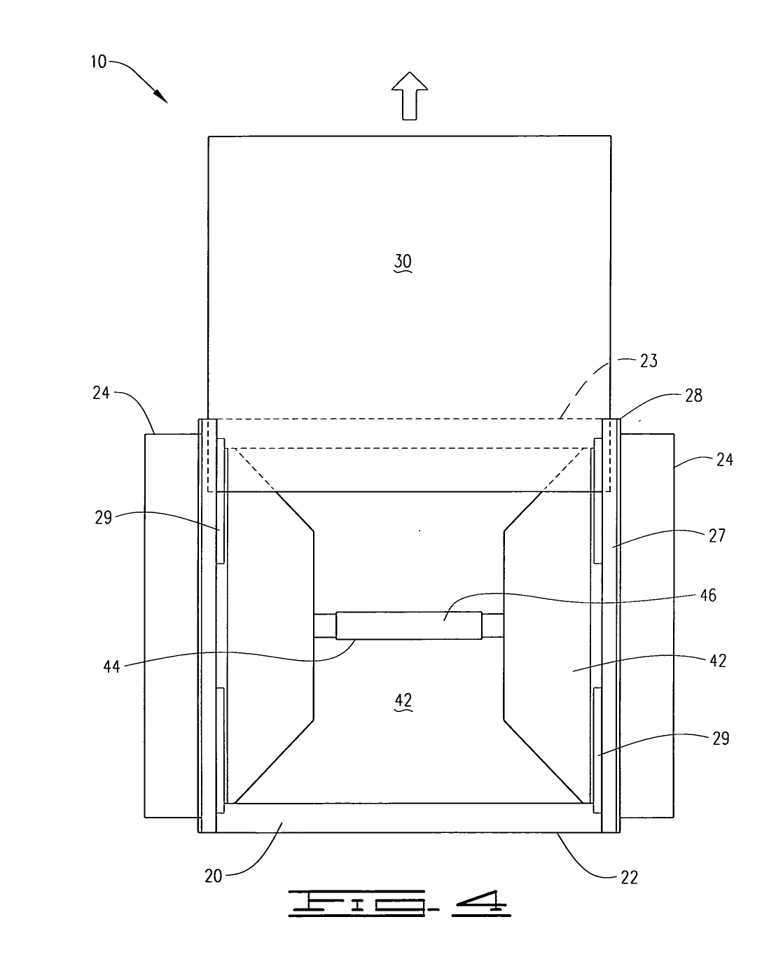

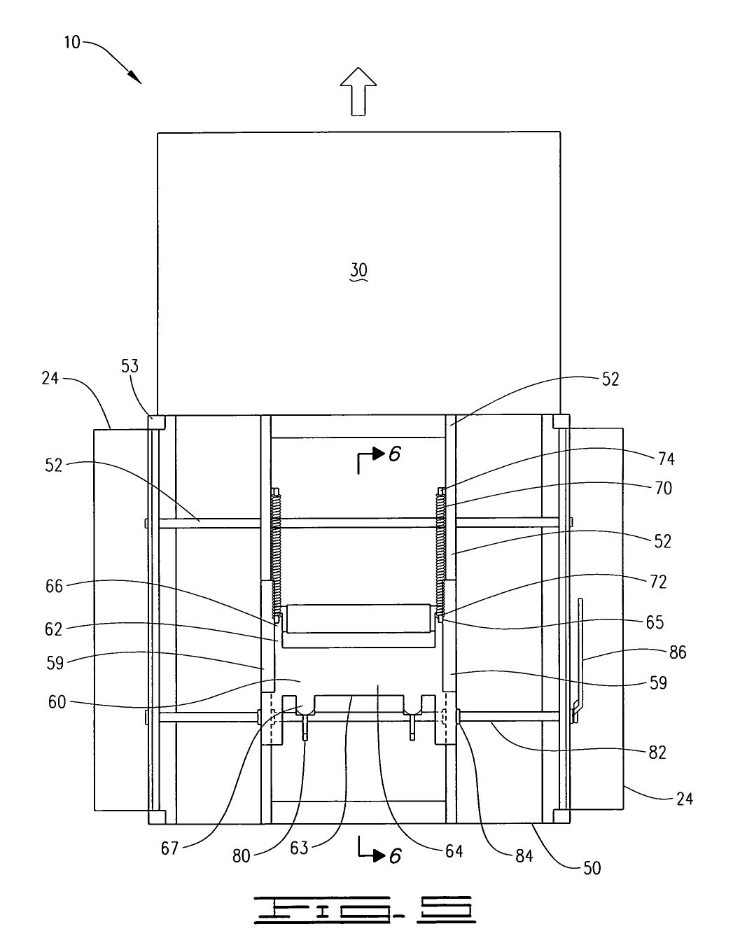

A bulk feed storage and transport bin 10, shown in FIGS. 1-7 of the drawings, for the bulk handling of a particulate feed for livestock or other particulate bulk material, the bin 10 defining a rectangular feed hopper 20 defining a front panel 22, a back panel 23 and two expanded lateral side panels 24 attached to one another, an upper rim 25 defined by the upper edge 26 of the feed hopper 20, the upper rim 25 extending upper lid slide rails 27 from each side panel 24, each slide rail 27 defining a lateral lid slide channel 28 and an upper contoured support extension 29, and a lower edge 40 of the hopper 20 attaching a lower tapered floor 42 forming a lower rectangular port 44 terminating into a lower opening 46. The expanded lateral side panels 24 are expanded outward, as shown in FIGS. 1, 2 and 4, for expanded volume capacity of the hopper 20. The hopper 20 is mounted upon a lower section 50 providing a support frame 52 and a lower support stand 53, the lower support stand 53 defining a front section 54, two side sections 55 and a rear section 56 defining a cavity 57, each section attaching to the support frame 52 within the cavity 57, the front section 54 further defining a pair of horizontally level fork slots 58 providing entry within the cavity 57 below a portion of the support frame 52 providing a point of insertion to receive lifting forks from transport equipment to lift and handle the bin 10. A sliding lid 30 slide horizontally within the facing slide channels 28 of the upper lid slide rails 27, the lid horizontally moved from front to back. A lower chute door 60 is slideably engaged below the lower rectangular port 44 and lower opening 46 in close proximity to the lower opening 46, the lower chute door 60 retaining the contents of the hopper 20, FIGS. 5-7. The expanded side panels 24, for purposes of expanded capacity of the hopper, may extend laterally without limits, provided the lower section 50 provides a dimension to be transported in the bed of a standard farm pickup, most commonly a half ton to one ton pickup bed.

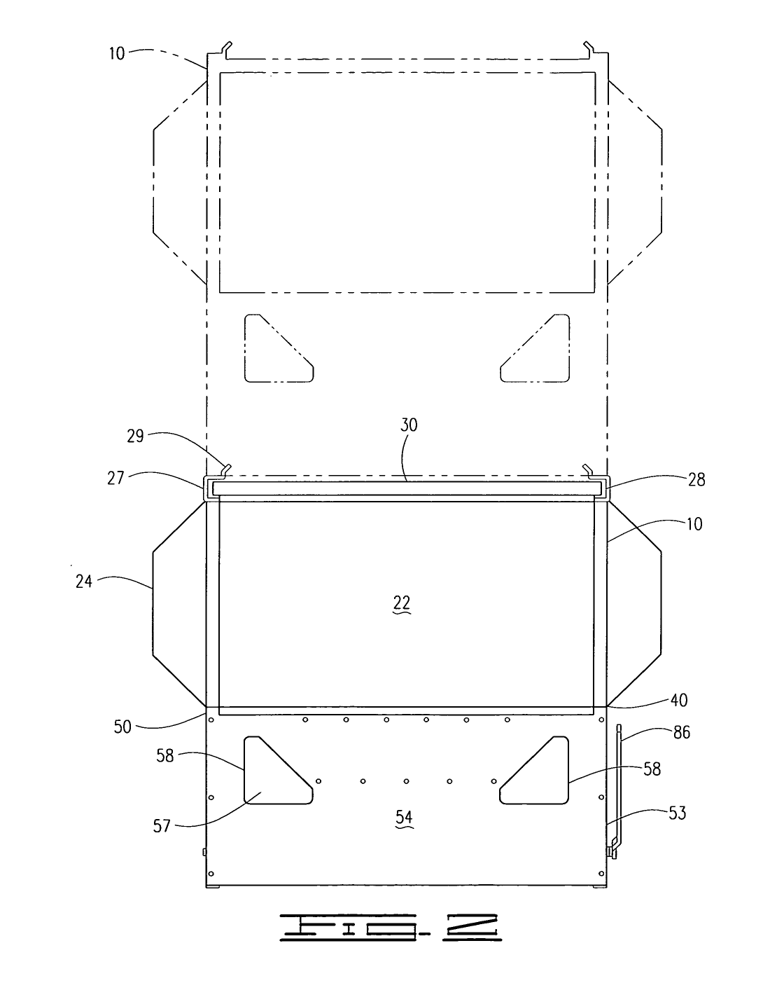

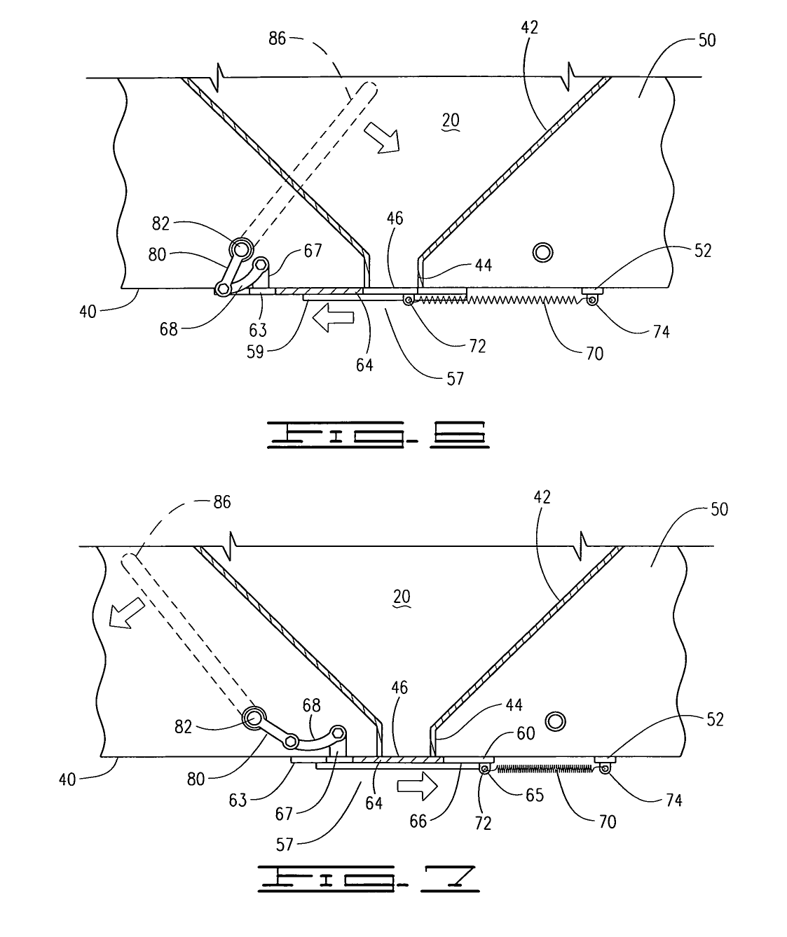

The lower chute door 60, FIG. 5, further defines lateral margins 62 slidably engaged within a pair of lower lateral slide rails 59 attached to the support frame 52, a front section 63 attached to a pair of tension springs 70 on each lateral margin 62 of the lower chute door 60 and a rear section 66 attached to a pair of articulated arms 80 attached to a rotatable axle 82 below the support frame 52 by a pair of side mounted axle bearings 84 with the axle 82 extending a lever 86 being pivotal on a vertical axis along one of the side sections 55 of the lower support stand 53. The lever 86 is moved by force into an open position, FIG. 6, urging the lower chute door 60 to the rear, exposing the lower opening 46 to dispense the hopper contents. When the lever 86 is without force and in a closed position, FIG. 7, the lower chute door 60 is returned by the tension of the springs 70 to close the lower opening 46. The lower chute door 60 is operable whether the bin 10 is set upon a ground surface, on a elevated object or when it is stacked upon another bin 10, FIG. 2, providing each bin 10 with the ability to transfer its contents into another bin 10 below by opening the sliding lid 30 of the lower stacked bin 10 and opening the lower chute door 60 of the upper stacked bin 10 providing transfer of the contents of the upper bin into the lower bin.

The lower chute door 60, FIGS. 5-7, further defines an H-shaped panel with the lateral margins 62 being elongated with a door panel section 64 being defined by the same dimension as the lower opening 46 of the lower rectangular port 44 with each lateral margin 62 defining a forward spring anchor point 65, each spring anchor point 65 receiving a first end 72 of each tension spring 70, with a second end 74 of each tension spring 70 mounted to the support frame 52 below the fork slots 58 to avoid damage to or interference with the operation of the springs 70 and attached lower chute door 60. The lower chute door 60 further defines a rear section 66 extending a pair of door tabs 67 attaching a pivotal link 68, FIGS. 6-7, each link 68 further attaching to one of the pair of articulated arms 80 attached to the axle 82 which move in cooperation to convert the vertical axial rotation of the rotatable axle 82 caused by movement of the lever 86 into a horizontal linear force against the lower chute door 60 and against the tension springs 70 to compel the lower chute door 60 to movement towards the rear. Release of the lever 86 returns the chute door 60 to the closed position without force required from the user. The lower chute door 60 would be closed automatically when no force is present and opened only by intentional force.

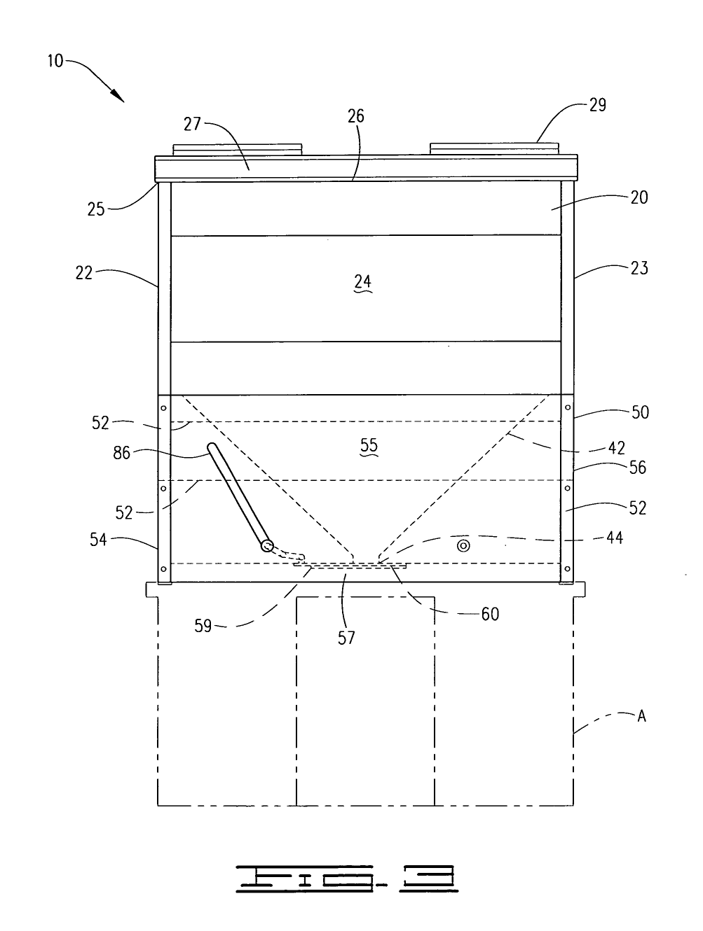

The exchange format use of the present bulk feed bin 10 is patterned after the propane tank exchanges, where a consumer exchanges their empty portable tank for a full tank repeatedly as opposed to having to wait for the tank to be filled at a location or for a feed delivery service to fill the tank. The bins 10 can also be delivered by the feed merchant to the rancher or consumer with multiple feed bins on a trailer, delivering full bins and retrieving empty ones on a subscription route. Each bin is adapted for use independently, while mounted upon a pair of lower support stands, attached to the lower section of the bin, or while mounted upon a stack base support A, FIGS. 1 and 3, upon which the bin is mounted, the stack base support receiving buckets or other smaller quantity transport devices.

The bulk feed bins 10, being ideally suited for inclusion within other systems, can be provided as integrated vehicle or implement transport systems or simply used independently. The fork slots 58 provide transport capability so that each bin 10 can be moved with skid steering equipment, tractors with hay forks, or a fork lift implements at the farm and ranch location or at the distributor. The slide rails 27 and support extensions 29 allow the bins to be stacked upon one another for storage or transport with the support extensions 29 of the lower stacked bin 10 securely supporting the lower support stand 53 of the upper stacked bin 10, while allowing the upper sliding lid 30 and the lower chute door 60 to be opened and closed independently while stacked, FIG. 2. This stacking also provides the bins 10 with the option to transfer contents from an upper stacked bin into a lower stacked bin, leaving the lower bin filled and for use while the upper bin is removed and taken in for refill or exchange or simply emptying a bin while suspended above another. Other uses will be apparent once the full utility of the device is understood by those skilled in the art and the industry.

The primary benefits of having the bulk feed bins 10, as disclosed, lies within the ability of a user to purchase, haul and deliver particulate feed in bulk quantities, reducing the handling required in bagged feed, and also providing the storage bin in the disclosed profile, which allows for each storage bin to be carried within the bed of a pickup, as disclosed previously, or hauled on a flat bed semi-trailer which would provide transport for up to 26 storage bins per level, or 52 storage bins in a two-high stacked and secured transport. Another advantage over other storage bins lies within each upper bin being stacked upon a lower bin and maintaining the ability to empty the upper bin contents into the lower bin by the operation of the sliding lid and the lower chute door while stacked.

This enables the user to empty the lower storage bin, or other component integrated within a feed distribution system, and then dispense the contents of an upper storage bin into the lower storage bin or other component. The now empty upper storage bin may then be replaced with a newly filled storage bin, with the lower storage bin remaining in place while the upper storage bin is repeatedly refilled or replaced.

It is contemplated that the feed storage bin 10, due to its disclosed utility, can be integrated with other accessory implements, including an auger to move the particulate feed horizontally for delivery into feed troughs or to other mobile devices (filed contemporaneously with the present application), or pickup beds, feed spreaders, feed mixers, uplift devices, or a replacement accessory on a front end loader. It can be used as part of an overall feed delivery system at a farm or ranch or feed lot, with the bins used like a cartridge to constantly refill the system with a supply of bulk feed. While the feed storage bin has been particularly shown and described with reference to a preferred embodiment thereof, it will be understood by those skilled in the art that changes in form and detail may be made therein without departing from the spirit and scope of the invention.

What is claimed is:

1. A bulk feed storage and transport bin providing bulk handling of a particulate feed for livestock or other particulate bulk material, the bin comprising:
a rectangular feed hopper defining a front panel, a back panel and two expanded lateral side panels attached to one another, an upper rim defined by an upper edge of said hopper, and a lower edge of said hopper attaching a lower tapered floor forming a lower rectangular port terminating into a lower opening;
upper lid slide rails attached to each said upper edge above each said side panel, each slide rail defining a lateral lid slide channel and an upper contoured support extension;
a sliding lid sliding horizontally within said facing slide channels of said upper lid slide rails, said lid horizontally moved from front to back;
a lower section providing an internal support frame and a lower support stand, said lower support stand defining a front section, two side sections and a rear section further defining a cavity, each section attaching to said support frame, said front section further defining a pair of horizontally level fork slots for entry within said cavity below said support frame providing a point of insertion for lifting forks from equipment to lift and handle said bin; and
a lower chute door is slideably engaged below said lower rectangular port and said lower opening in close proximity to said lower opening, said lower chute door retaining said particulate feed or other particulate bulk material within said hopper, said lower chute door further defining lateral margins slidably engaged within a pair of lower lateral slide rails attached to said support frame, a front section attached to a pair of tension springs on each said lateral margin, and a rear section attached to a pair of articulated arms extending from a rotatable axle held below said support frame by a pair of side mounted axle bearings, with said axle further extending a lever which is pivotal on a vertical axis along side one said side sections of said lower support stand, said lever moved by force into an open position urging said lower chute door to the rear, exposing said lower opening to dispense said hopper contents and said lever released, returning said chute door into a closed position, said lower chute door returned by the tension of said springs to close the lower opening.

2. The feed storage and transport bin as disclosed in claim 1, said lower chute door further comprising:
an H-shaped panel with said lateral margins being elongated with each said lateral margin defining a forward spring anchor point, each said spring anchor point receiving a first end of each said tension spring, with a second end of each tension spring mounted to said support frame below said fork slots to avoid damage to or interference with an operation of said springs and said lower chute door;
a door panel section defined by the same dimension as said lower opening of said lower rectangular port; and
a rear section extending a pair of door tabs attaching a pivotal link, each said link further attaching to one of said pair of articulated arms attached to said axle, wherein said door tabs, pivotal link and said articulated arms move in cooperation to convert said vertical axial rotation of said lever through said rotatable axle into a horizontal linear force against said lower chute door and against said tension springs to compel said lower chute door to the rear.

3. The bulk feed storage and transport bin as disclosed in claim 1, further comprising:
said slide rails and said support extensions allow said bins to be stacked upon one another for storage or transport with said support extensions of one said lower bin securely supporting said lower support stand of one said upper stacked bin, while permitting said upper sliding lid of said lower stacked bin and said lower chute door of said upper stacked bin to be opened and closed independently while stacked; and
said lower chute door is operable whether said bin is set upon a ground surface, on a elevated object or when it is stacked upon another bin , providing each said bin with the capability of transferring said bulk feed or other particulate bulk material within said hopper of said upper bin into said hopper of said lower bin by opening said sliding lid of said lower stacked bin and opening said lower chute door of said upper stacked bin, wherein said stacking capability also provides said bins with the option of transfer contents from said upper stacked bin into said lower stacked bin, as disclosed, providing said lower bin in a stationary location while said upper bin is removed and taken in for refill or exchange, or simply emptying a bin while suspended above another by transport equipment.

4. The bulk feed storage and transport bin as disclosed in claim 1, further comprising any other feature as disclosed within the specification.
